(19) United States
(12) Patent Application Publication
(10) Pub. No.: US 2013/0228235 A1
(43) Pub. Date: Sep. 5, 2013

(54) LUBRICATING VALVE TRAIN CARRIER

(71) Applicants: Kiran Shridhar Joshi, Mumbai (IN); Kiran Nagaraj Bairy, Pune (IN); Sanjay Parshuram Chopane, Pune (IN)

(72) Inventors: Kiran Shridhar Joshi, Mumbai (IN); Kiran Nagaraj Bairy, Pune (IN); Sanjay Parshuram Chopane, Pune (IN)

(73) Assignee: EATON CORPORATION, Cleveland, OH (US)

(21) Appl. No.: 13/411,708

(22) Filed: Mar. 5, 2012

(51) Int. Cl. F16K 51/00

(52) U.S. Cl. 137/351

(57) ABSTRACT

A valve train carrier comprises an enclosed main passage configured to be in pressure communication with pressurized engine oil and an enclosed secondary passage adjacent the main passage. An oil barrier between the main passage and secondary passage is configured to permit oil flow from the main passage to the secondary passage such that the secondary passage receives oil from the main passage at a lower pressure than oil in the main passage. Outlet passages permit discharge of oil from the carrier.

### BACKGROUND

The present disclosure relates to valve train carriers and valve train carrier assemblies. Carrier assemblies have valve train components pre-mounted to carriers. Valve train components, for example rocker arms, hydraulic lash adjusters, valve assemblies and related attachments and mechanisms may be mounted to the carrier, minimizing the number of separate components that must be installed and allowing for more efficient installation of the valve train components.

### SUMMARY

A valve train carrier comprises an enclosed main passage configured to be in pressure communication with pressurized engine oil and an enclosed secondary passage adjacent the main passage. An oil barrier between the main passage and secondary passage is configured to permit oil flow from the main passage to the secondary passage such that the secondary passage receives oil from the main passage at a lower pressure than oil in the main passage. Outlet passages permit discharge of oil from the carrier.

### BRIEF DESCRIPTION OF THE DRAWINGS

It will be appreciated that the illustrated boundaries of elements in the drawings represent only one example of the boundaries. One of ordinary skill in the art will appreciate that a single element may be designed as multiple elements or that multiple elements may be designed as a single element.

Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1 illustrates a perspective view of an exemplary carrier assembly 100.

FIG. 2 illustrates an exploded view of the carrier assembly 100 illustrated in FIG. 1.

FIG. 3 illustrates a sectional view along the line 3-3 shown in FIG. 1.

### DETAILED DESCRIPTION

Certain terminology will be used in the following description for convenience in reference only and will not be limiting. The terms “upward,” “downward,” “upper,” and “lower” will be understood to have their normal meanings and will refer to those directions as the drawing figures are normally viewed.

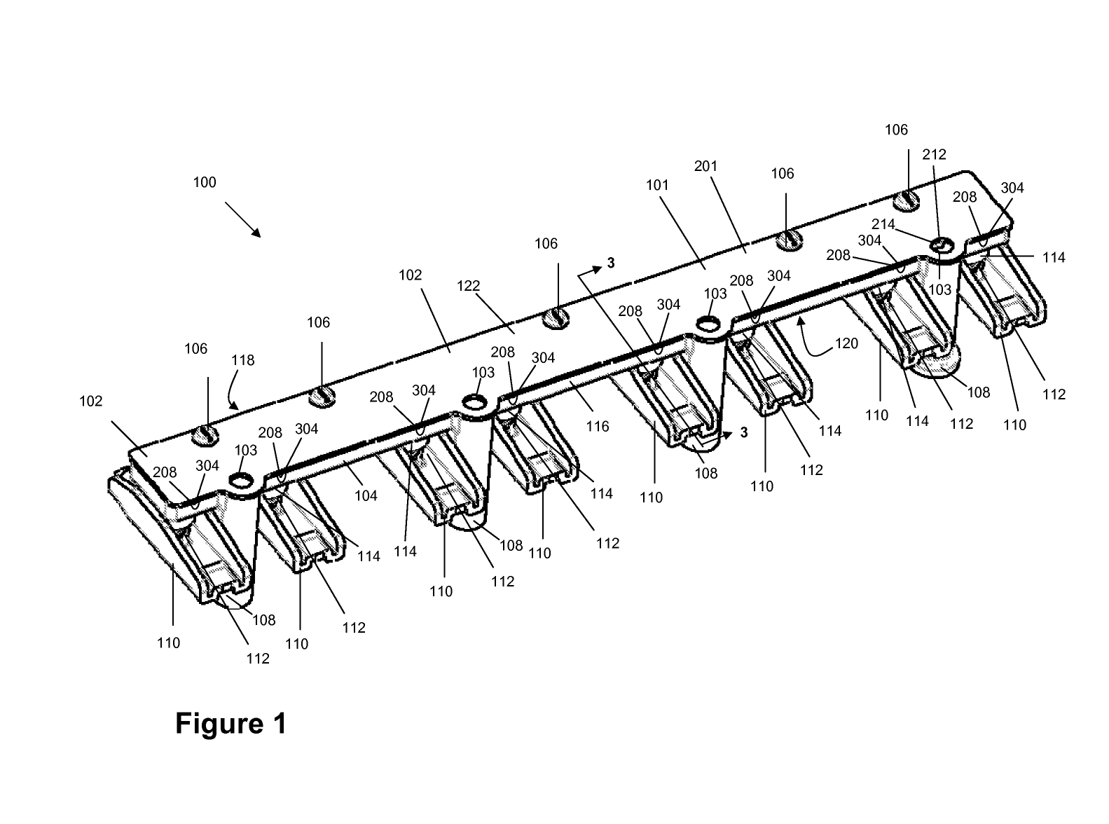

FIG. 1 illustrates a perspective view of an exemplary valve train carrier assembly 100 according to the present disclosure. Such a carrier assembly 100 may be used to pre-mount multiple components of a valve train, such as a lash adjuster or rocker arm, allowing for greater efficiency in installing these components in an internal combustion engine. According to one aspect of the present disclosure, multiple rocker arms 110 and lash adjusters 112 are mounted to assembly 100.

Carrier assembly 100 has a carrier 101. Carrier 101 has a cover 102 in the form of a top plate secured to a main body 104 of the carrier 101 with fasteners 106, corresponding to five screws. Cover or top plate 102 also has holes 103 disposed over engine block mounts 108 that permit passage of pressurized engine oil through top plate 102. Carrier 101 shown in FIG. 1 has four engine block mounts 108 that are secured to the engine block (not shown) when carrier 101 is installed in an internal combustion engine. Adjacent each of the engine block mounts 108 are two rocker arms 110, one on each side of the engine block mounts 108. Each rocker arm 110 is mounted to carrier 101 through a lash adjuster 112. Each lash adjuster 112, in turn, is placed within a lash adjuster seat or boss 114, which is part of main body 104.

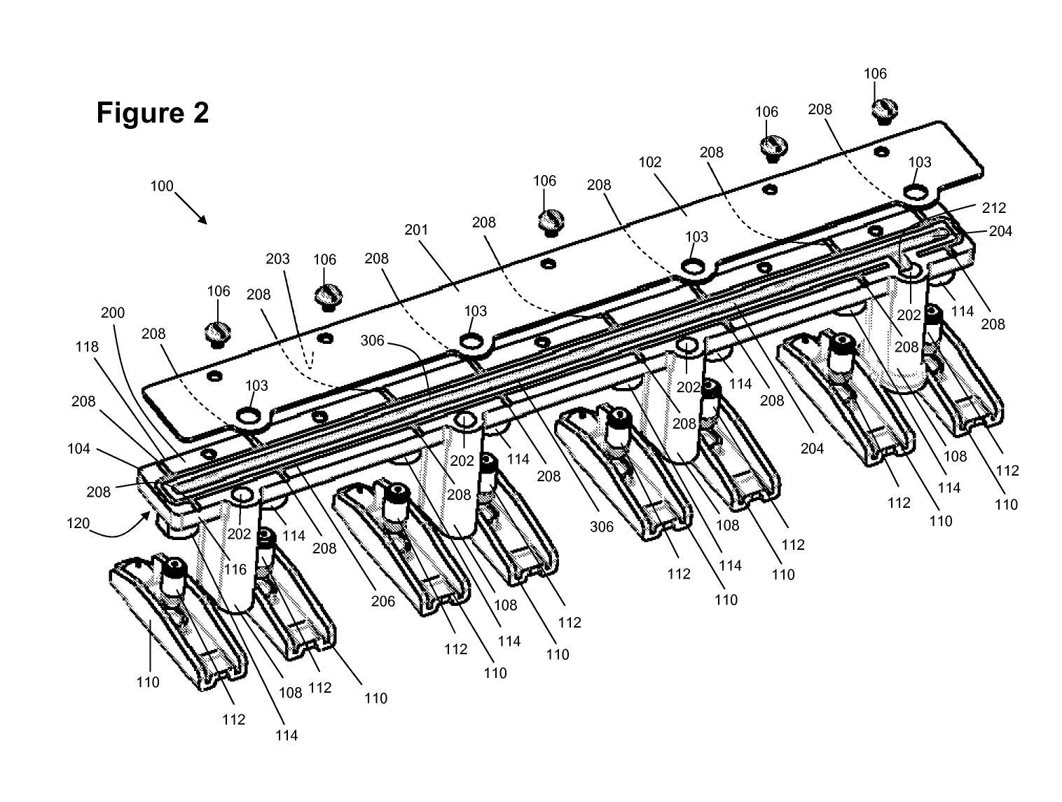

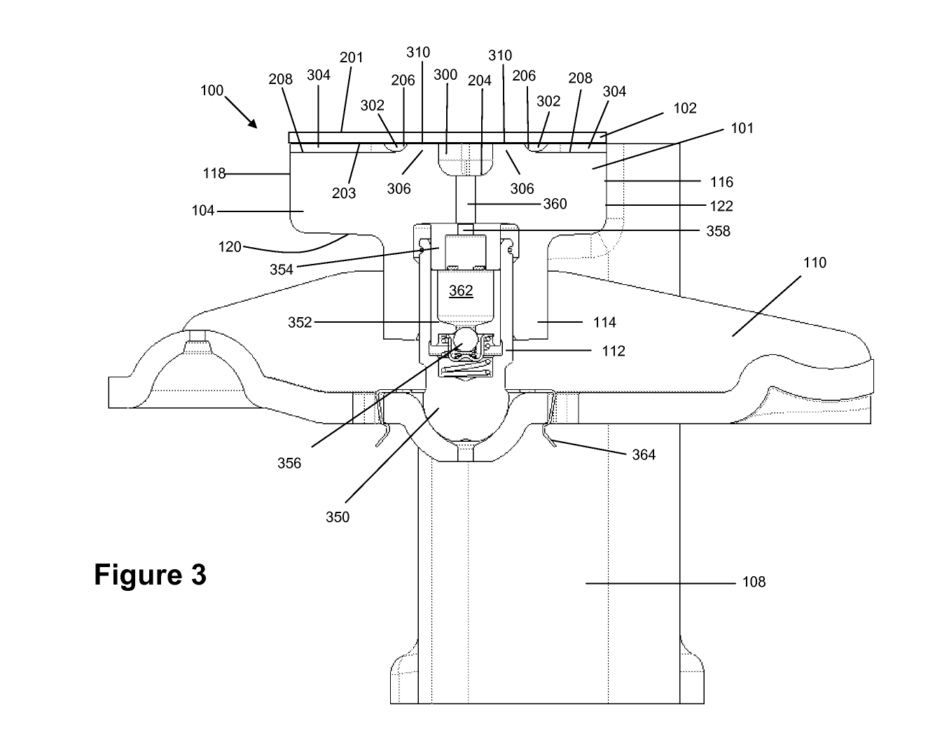

FIG. 2 illustrates an exploded perspective view of valve train carrier 101 shown in FIG. 1. As shown in FIG. 2, main body 104 has a top surface 200 that serves as a receiving surface for top plate 102. Top plate 102 has an upper surface 201 and lower surface 203, lower surface 203 serving as a carrier body interfacing surface. Top surface 200 of main body 104 has a main groove 204, a secondary groove 206 that almost completely surrounds main groove 204, and outlet grooves 208 that extend from secondary groove 206 to one of a first 116 and second 118 lateral surface of main body 104, the first 116 and second 118 lateral surfaces extending between top plate 102 and a lower surface 120 of carrier 101. Once top plate 102 is secured to main body 104, lower surface 203 forms passages with main groove 204, secondary groove 206 and outlet grooves 208. As illustrated in FIG. 3, main groove 204 and lower surface 203 form an enclosed main passage 300, secondary groove 206 and lower surface 203 form an enclosed secondary passage 302, and outlet grooves 208 and lower surface 203 form enclosed outlet passages 304. Eight outlet passages 304 are distributed along each of first 116 and second 118 lateral surfaces and adjacent top plate 102. When carrier 101 is assembled, outer surface 122 of carrier 101 comprises upper surface 201 of top plate 102, first 116 and second 118 lateral surfaces, and lower surface 120 of carrier 101.

With further reference to FIG. 2, the four engine block mounts 108 are hollow, each having a passage 202 for receiving a fastener (not shown). The passage 202 adjacent the inlet groove 212 is shaped to allow pressurized engine oil to flow past the fastener (not shown) disposed within the passage 202 during engine operation and reach the inlet groove 212. The passage 202 adjacent the inlet groove 212 may have, for example, a channel or recess creating a space that allows for oil to pass the fastener (not shown). The passage 202 adjacent inlet groove 212 is in fluid pressure communication (or “pressure communication”) with a main groove 204 through inlet groove 212, which forms inlet passage 214 with lower surface 203 of top plate 102. As used herein, “pressure communication” denotes communication of fluid (e.g., engine oil) at the same or substantially the same pressure. Pressurized oil travels from passage 202 through inlet passage 214 to main passage 300 formed by main groove 204.

Secondary groove 206 shown in FIG. 2 is continuous and substantially surrounds main groove 204. This configuration of secondary groove 206 permits even oil distribution across the entire secondary passage 302. Other configurations that permit even oil distribution across one or more secondary passages are also possible. In one such example, several discontinuous secondary passages collect oil from main passage 300, such as may be the case when multiple inlet grooves 212 supply main passage 300 with pressurized oil. According to one aspect of the present teachings, oil may be supplied through more than one of the engine block mounts 108.

While the illustrated assembly 100 shows main groove 204, secondary groove 206 and outlet grooves 208 as grooves formed on main body 104, the present disclosure is not so limited. For example, in an alternative assembly, one or more of a main groove 204, secondary groove 206 and outlet grooves 208, or a portion thereof, may be formed in a cover 102 that interfaces an upper surface on main body 104 of an alternative carrier 101, forming various passages. In yet another assembly, one or more of a main groove 204, secondary groove 206 and outlet grooves 208 may be formed in both a main body 104 of a carrier 101 and a cover 102. Still other combinations of grooves disposed on one or both of a main body 104 or cover 102 of a carrier are possible according to the present disclosure.

FIG. 3 illustrates a sectional view taken along line 3-3 show in FIG. 1. A lash adjuster 112 has an outer body 350, plunger 352, socket 354 and check ball assembly 356. Socket passage 358 is in pressure communication with main passage 300 through lash adjuster passage 360, allowing high pressure oil to enter an internal cavity 362 of lash adjuster 112. Clip 364 prevents rocker arm 110 from separating from lash adjuster 112. Lash adjuster 112 is located within lash adjuster seat 114 of main body 104. While in the illustrated configuration rocker arm 110 is mounted to carrier 101 indirectly through lash adjuster 112, the present disclosure is not so limited. In one alternative example, rocker arm 110 may be directly, pivotably secured to a carrier 101. In such an alternative configuration, a lash adjuster or tappet may be disposed elsewhere in the valve train, such as between the cam and rocker arm 110, or between the valve and rocker arm 110.

As illustrated in FIG. 3, main passage 300 is separated from secondary passage 302 by barrier 306. Barrier 306 forms a narrow, oil permeable seal 310 with lower surface 203 of top plate 102. When the engine is not operating and any transient oil pressure has worn off, the oil in main passage 300 is not under pressure and thus does not flow across barrier 306. Under such circumstances, barrier 306 may be in contact with lower surface 203 of top plate 102. In other aspects of the present disclosure, lower surface 203 of top plate 102 and barrier 306 may form a thin passage through which pressurized engine oil passes from main passage 300 to secondary passage 302. When the engine is operating and pressurized oil is present in main passage 300, pressurized oil is able to pass through seal 310. Seal 310 reduces the pressure of the oil as it passes across seal 310 from main passage 300 to secondary passage 302. The reduction in pressure is due at least in part to fluid forces within the oil that causes a reduction is pressure as the oil crosses seal 310. Due to the thinness of seal 310, frictional forces within the oil reduce the pressure of the oil as it passes from the high pressure main passage 300 to the lower pressure secondary passage 302. The reduction in pressure has a positive relationship with the sectional width of seal 310. The greater the distance the oil must traverse across the width of seal 310, the lower the pressure in secondary passage 302 relative to a particular pressure in main passage 300. Such a pressure reduction will also occur when a sufficiently narrow passage is formed by barrier 306 and lower surface 203 of top plate 102.

Thus, oil received in secondary passage 302 from main passage 300 is not at the pressure level of pressurized engine oil, but rather at a lower pressure suitable for discharging oil from outlet passages 304 and onto valve train components such as rocker arms 110. As shown in FIG. 2, outlet grooves 208 and outlet passages 304 are disposed above rocker arms 110. Oil exits carrier 101 as it is discharged from outlet passages 304 directly onto rocker arms 110, where it can the flow further downward into the valve train, thereby lubricating, for example, rocker arms 110, the cam (not shown) and the valves and associated valve components (not shown).

For the purposes of this disclosure and unless otherwise specified, “a” or “an” means “one or more.” To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components. As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. From about X to Y is intended to mean from about X to about Y, where X and Y are the specified values.

While the present disclosure illustrates various aspects of the present teachings, and while these teachings have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing teachings are illustrative, and no single feature or element is essential to all possible combinations that may be claimed in this or a later application.

1. A valve train carrier, comprising:
an enclosed main passage configured to be in pressure communication with pressurized engine oil;
an enclosed secondary passage adjacent the main passage;
an oil barrier between the main passage and secondary passage configured to permit oil flow from the main passage to the secondary passage such that the secondary passage receives oil from the main passage at a lower pressure than oil in the main passage; and,
at least one outlet passage configured to be in pressure communication with the secondary passage and extending from the secondary passage to an outer surface of the carrier, the outlet passage configured to permit discharge of oil from the carrier.

2. The valve train carrier of claim 1, wherein the carrier is configured to have at least one rocker arm mountable to the carrier, the at least one outlet passage positioned to discharge oil upon the at least one rocker arm.

3. The valve train carrier of claim 1, further comprising:
a carrier body having an upper surface configured to receive a cover and having a main groove, a secondary groove, and the oil barrier;
a cover having an upper surface and a carrier body interfacing surface, wherein the carrier body interfacing surface is configured to form an oil permeable seal with the barrier.

4. The valve train carrier of claim 3 wherein the secondary groove at least partially surrounds the main groove.

5. The valve train carrier of claim 1, further comprising:
a carrier body having an upper surface configured to receive a cover and having a main groove, a secondary groove, outlet grooves and the oil barrier;
a cover having an upper surface and a carrier body interfacing surface, wherein the carrier body interfacing surface is configured to form an oil permeable seal with the oil barrier, and wherein the main passage comprises the main groove and carrier body interfacing surface, the secondary passage comprises the secondary groove and carrier body interfacing surface, and the outlet passage comprises the outlet groove and carrier body interfacing surface.

6. The valve train carrier of claim 5 wherein the secondary groove at least partially surrounds the main groove.

7. The valve train carrier of claim 1, further comprising:
a carrier body having an upper surface configured to receive a cover;
the cover having an upper surface and a carrier body interfacing surface; and,
wherein the carrier body interfacing surface and upper surface form the main passage, secondary passage and outlet passage.

8. The valve train carrier of claim 7, wherein the upper surface of the carrier body and the carrier body interfacing surface form a narrow oil permeable passage configured to permit flow of oil from the main passage to secondary passage such that the secondary passage receives oil from the main passage at a lower pressure than oil in the main passage.

9. A valve train carrier body, comprising:
an upper surface having a main groove configured to be in pressure communication with pressurized oil, a secondary groove adjacent the main groove, an oil barrier between the main groove and secondary groove, and at least one outlet groove in pressure communication with the secondary groove;
the upper surface configured to receive a top plate having a carrier body interfacing surface, wherein the carrier body interfacing surface is configured to form an oil permeable seal with the oil barrier.

10. The valve train carrier body of claim 9, wherein the carrier body is configured to have at least one rocker arm mountable to the carrier body, the at least one outlet groove positioned to discharge oil upon the at least one rocker arm.

11. The valve train carrier body of claim 9, wherein the oil permeable seal is configured to permit flow of oil from the main groove to the secondary groove, the oil received at the secondary groove at a pressure lower than a pressure of oil in the main groove.

12. The valve train carrier body of claim 9, wherein the secondary groove at least partially surrounds the main groove.

13. A valve train carrier assembly, comprising:
a carrier body having a lower surface and upper surface, the upper surface configured to receive a top plate and having a main groove, a secondary groove, outlet grooves and oil barrier;
a top plate having an upper surface and a carrier body interfacing surface, wherein the carrier body interfacing surface is configured to form an oil permeable seal with the oil barrier;
a plurality of lash adjuster seats disposed on the lower surface, each seat configured to receive a rocker arm assembly comprising a lash adjuster and rocker arm;
at least one engine block mount having a pressurized oil passage configured to be in pressure communication with pressurized engine oil and a main passage comprised of the main groove and the carrier body interfacing surface;
a secondary passage adjacent the main passage and comprised of the secondary groove and the carrier body interfacing surface;
the oil barrier and carrier body interfacing surface forming an oil permeable seal configured to permit oil flow from the main passage to the secondary passage such that the secondary passage receives oil at a lower pressure than a pressure of the oil in the main passage; and,
an outlet passage configured to permit oil in the secondary passage to discharge from the carrier assembly.

14. A valve train carrier assembly of claim 13, further comprising:
a first lateral surface and a second lateral surface between the upper surface and lower surface of the carrier body;
at least one outlet passage configured to permit oil to discharge from the first lateral surface; and,
at least one outlet passage configured to permit oil to discharge from the second lateral surface.

15. A valve train carrier assembly of claim 14 wherein the at least one outlet passage on the first lateral surface and at least one outlet passage on the second lateral surface are configured to discharge oil on each of the rocker arm assemblies.

16. The valve train carrier assembly of claim 14, wherein the secondary passage at least partially surrounds the main passage.

17. The valve train carrier assembly of claim 16, wherein the secondary passage is continuous.

18. The valve train carrier assembly of claim 14, wherein the secondary passage substantially surrounds the main passage.

19. The valve train carrier assembly of claim 14 further comprising at least one lash adjuster passage in pressure communication with the main passage and an interior cavity of a hydraulic lash adjuster.

20. The valve train carrier assembly of claim 14 further comprising an inlet passage extending from the pressurized oil passage to the main passage.
